(19) United States
(12) Patent Application Publication
(10) Pub. No.: US 2026/0236021 A1
(43) Pub. Date: Aug. 13, 2026

(54) COMMUNICATION SYSTEM FOR UNMANNED AIRCRAFT SYSTEM AND METHOD THEREFOR

(71) Applicants: Hyundai Motor Company, Seoul (KR); Kia Corporation, Seoul (KR)

(72) Inventor: Jun Young LIM, Hwaseong-Si (KR)

(21) Appl. No.: 19/331,608

(22) Filed: Sep. 17, 2025

(30) Foreign Application Priority Data
Feb. 11, 2025 (KR) 10-2025-0017456

(51) Int. Cl. G05D 1/226; G05D 1/222; G05D 109/20; G08G 5/26; H04B 7/185

(52) U.S. Cl. CPC G05D 1/226; G05D 1/222; G08G 5/26; H04B 7/18506; G05D 2109/20

(57) ABSTRACT

A communication system may comprise a remote pilot server configured to communicate with an aircraft via at least one link to control flight of the aircraft, and a control server configured to communicate with the aircraft to provide a flight route of the aircraft, wherein at least one of the remote pilot server or the control server is configured to receive broadcast communication transmitted from the aircraft, wherein the broadcast communication is based on a loss in the at least one link, and wherein, based on detection of the loss, the remote pilot server and the control server are configured to perform terrestrial communication between the remote pilot server and the control server.

### CROSS-REFERENCE TO RELATED APPLICATION

This application claims the benefit of priority to Korean Patent Application No. 10-2025-0017456, filed in the Korean Intellectual Property Office on Feb. 11, 2025, the entire contents of which are incorporated herein by reference.

### TECHNICAL FIELD

The present disclosure relates to a communication system for an unmanned vehicle (e.g., aircraft) system and a method therefor, and more particularly, relates to technologies for determining a loss in multiple communication links and controlling communication of the unmanned aircraft system depending on the determined result.

### BACKGROUND

Unmanned aircraft systems (UAS) or remotely piloted aircraft systems (RPAS) may include a communication system for control, such as takeoff/cruising, flight control, and landing/recovery of a mobility apparatus. Herein, the mobility apparatus may include an unmanned aircraft or any unmanned vehicle. The unmanned aircraft may be referred to as a remotely piloted aircraft (RPA). Such UAS may be composed of a mobility apparatus, a remote pilot station (RPS), air traffic control (ATC), and a communication link.

The communication link may include a communication, command and control (C2) link. The C2 link may refer to a wireless communication link between the mobility apparatus and the RPS. In other words, the C2 link is a data link (ICAO Doc 10019) for transmitting and receiving data for a command signal and a control signal of flight operation purposes. The communication link may include air traffic control (ATC) communication. The ATC communication may refer to a wireless communication link between the mobility apparatus and the ATC. The ATC communication is communication in which the ATC assigns the mobility apparatus a control instruction and control permission about a flight interval setting, a takeoff and landing order, a time, a flight route, a flight method, or the like. For example, the ATC communication is a relatively high frequency (VHF) communication using the frequency in the 100-150 MHz band. Furthermore, the communication link may include a relay link between a pilot and the ATC. For example, the relay link is a communication link for relaying a voice and data between the ATC and the RPS via the mobility apparatus. Thus, the communication link may be an important element in the UAS.

A mission execution procedure of the mobility apparatus, such as RTCA DO-400, has been standardized to prepare for the case in which a loss occurs in the communication link, in the technology of the UAS. Herein, RTCA DO-400 is a code described in the standards manager web standards list of the Radio Technical Commission for Aeronautics (RTCA), which is a code for a standardized C2 link loss procedure for the UAS. Simultaneously, as a security issue of the communication link of the UAS, such as mobility apparatus hijacking or communication disturbance, is considered.

In detail, as described above, in an UAS, the ATC and the RPS may communicate with each other via the mobility apparatus using the relay link. Thus, if a loss occurs in the C2 link, there is a problem in which it is difficult for the ATC and a pilot of the RPS to communicate with each other. Simultaneously, there is a problem in which it is difficult for the ATC to know the loss in the C2 link.

A communication system technology of the UAS for safe flight operation and addressing the above problems is considered.

### SUMMARY

The present disclosure has been made to solve the above-mentioned problems occurring.

According to the present disclosure, a communication system may comprise a remote pilot server configured to communicate with an aircraft via at least one link to control flight of the aircraft, and a control server configured to communicate with the aircraft to provide a flight route of the aircraft, wherein at least one of the remote pilot server or the control server is configured to receive broadcast communication transmitted from the aircraft, wherein the broadcast communication is based on a loss in the at least one link, and wherein, based on detection of the loss, the remote pilot server and the control server are configured to perform terrestrial communication between the remote pilot server and the control server.

The communication system, wherein the remote pilot server may comprise a wireless transceiver configured to establish at least one communication channel via the at least one link, a processor, and a memory storing at least one instruction that, when executed by the processor communicating with the memory, is configured to cause the remote pilot server to select the at least one link to communicate with the aircraft and assign a priority to the at least one link, detect the loss in the at least one link and generate a notification signal, wherein the notification signal may comprise link status data of the at least one link based on the detection of the loss, and transmit, via the terrestrial communication, the notification signal to the control server.

The communication system, wherein the communication system may comprise the aircraft, and wherein at least one of the aircraft or the remote pilot server may comprise a processor, and a memory storing at least one instruction that, when executed by the processor communicating with the memory, is configured to cause the at least one of the aircraft or the remote pilot server to determine, based on a plurality of data packets received in the at least one link, whether the loss occurs, and communicate, via the broadcast communication, flight status data of the aircraft based on the determination of whether the loss occurs.

The communication system, wherein the at least one instruction, when executed by the processor communicating with the memory, is configured to cause the at least one of the aircraft or the remote pilot server to identify a quantity of data packets corresponding to normal data packets, and wherein the identified data packets are among a plurality of data packets received via the at least one link during a preset time period.

The communication system, wherein the at least one instruction, when executed by the processor communicating with the memory, is configured to cause the at least one of the aircraft or the remote pilot server to verify, using a checksum, the data packets to determine whether the data packets are the normal data packets.

The communication system, wherein the at least one instruction, when executed by the processor communicating with the memory, is configured to cause the at least one of the aircraft or the remote pilot server to determine a ratio of a quantity of the normal data packets to a quantity of the plurality of data packets received via the at least one link during the preset time period, and generate, based on the ratio, the link status data.

The communication system, wherein the at least one instruction, when executed by the processor communicating with the memory, is configured to cause the remote pilot server to, based on the ratio being less than a threshold, determine that the loss occurs in the at least one link, and receive, based on the determination of the loss, the link status data from the aircraft.

The communication system, wherein the at least one instruction, when executed by the processor communicating with the memory, is configured to cause at least one of the aircraft or the remote pilot server to, based on a determination that a loss occurs in all of the at least one link, perform the broadcast communication by communicating, via a broadcast communication link, the flight status data and the link status data.

The communication system, wherein the control server may comprise a processor, and a memory storing at least one instruction that, when executed by the processor communicating with the memory, is configured to cause the control server to determine that the aircraft flies along a predetermined flight route and generate, based on the predetermined flight route, a command signal for the flight route, and receive, via the terrestrial communication, the notification signal may comprise the link status data.

The communication system, wherein the at least one instruction, when executed by the processor communicating with the memory, is configured to cause the control server to, based on all of the at least one link being lost, generate the command signal, and transmit, via the terrestrial communication, the command signal to the remote pilot server.

According to the present disclosure, a method performed by a communication system, the method may comprise communicating, by a remote pilot server of the communication system, with an aircraft of the communication system via at least one link to control flight of the aircraft, communicating, by a control server of the communication system, with the aircraft to provide a flight route of the aircraft, receiving, by at least one of the remote pilot server or the control server, broadcast communication transmitted from the aircraft, wherein the broadcast communication is based on a loss in the at least one link, and based on detection of the loss, performing, by the remote pilot server and the control server, terrestrial communication between the remote pilot server and the control server.

The method, wherein the communicating with the aircraft via the at least one link may comprise establishing at least one communication channel via the at least one link, selecting the at least one link to communicate with the aircraft, assigning a priority to the at least one link, detecting the loss in the at least one link, generating a notification signal may comprise link status data of the at least one link based on the detection of the loss, and transmitting, via the terrestrial communication, the notification signal to the control server.

The method may further comprise determining, based on a plurality of data packets received in the at least one link, whether the loss occurs, and wherein the performing of the broadcast communication may comprise transmitting, via the broadcast communication, flight status data of the aircraft based on the determining of whether the loss occurs.

The method may further comprise identifying a quantity of data packets corresponding to normal data packets, wherein the identified data packets are among a plurality of data packets received in the at least one link during a preset time period.

The method, wherein the determining of whether the loss occurs may comprise verifying, using a checksum, the data packets to determine whether the data packets are the normal data packets.

The method may further comprise determining a ratio of a quantity of the normal data packets to a quantity of the plurality of data packets received via the at least one link during the preset time period, and generating, based on the ratio, link status data of the at least one link.

The method may further comprise based on the ratio being less than a threshold, determining that the loss occurs in the at least one link, and based on the determining of the loss, receiving, by the remote pilot server from the aircraft, the link status data.

According to the present disclosure, a vehicle control system may comprise a vehicle may comprise a plurality of primary wireless communication links configured to communicate with a remote pilot station and a control server, a broadcast communication link configured to transmit data using a broadcast protocol, at least one processor circuit operatively connected to the plurality of primary wireless communication links and the broadcast communication link, wherein the at least one processor circuit is configured to receive a plurality of data packets via the plurality of primary wireless communication links, verify, using a checksum, integrity of each of the plurality of data packets, determine, over a defined period, a ratio of data packets with verified integrity to a total number of data packets received, compare the ratio of data packets to a threshold ratio to detect a loss in at least one of the plurality of primary wireless communication links, generate, based on the comparison, link status data of the plurality of primary wireless communication links, transmit the link status data to the remote pilot station via an available one of the plurality of primary wireless communication links, and based on detecting a loss in all of the plurality of primary wireless communication links, transmit, via the broadcast communication link, operation status data of the vehicle and the link status data, the remote pilot station may comprise a terrestrial communication link, a broadcast communication link, and at least one processor circuit configured to, based on all of the plurality of primary wireless communication links being unavailable, receive, via the broadcast communication link, the link status data and the operation status data from the vehicle, generate a notification signal may comprise the link status data, and transmit the notification signal to the control server via the terrestrial communication link, based on restoration of at least one primary wireless communication link of the plurality of primary wireless communication links, transmit, via the at least one primary wireless communication link to the vehicle, a command signal for controlling the vehicle, and the control server may comprise a terrestrial communication link, and at least one processor configured to receive, via the terrestrial communication link of the control server, the notification signal from the remote pilot station, determine, based on the notification signal, a route for the vehicle, and transmit, via the terrestrial communication link of the control server, the command signal to the remote pilot station.

The vehicle control system, wherein the at least one processor circuit of the vehicle is further configured to, based on the detecting of the loss in all of the plurality of primary wireless communication links, perform at least one of a return-to-home operation or an automatic landing operation.

The vehicle control system, wherein the link status data of the plurality of primary wireless communication links may comprise, for each of the plurality of primary wireless communication links, a link status value indicating whether data packets have been successfully received during the defined period, the ratio of data packets with verified integrity to the total number of data packets received during the defined period, and a result of the comparison of the ratio of data packets with verified integrity to the threshold ratio.

### BRIEF DESCRIPTION OF THE DRAWINGS

The above and other objects, features and advantages of the present disclosure will be more apparent from the following detailed description taken in conjunction with the accompanying drawings:

FIG. 1 shows an example of an unmanned aircraft system;

FIG. 2 shows an example of a configuration of a communication system for an unmanned aircraft system;

FIG. 3 shows an example of a configuration of a remote pilot server;

FIG. 4 is an example of a communication link;

FIG. 5 is an example of link status data;

FIG. 6 is an example of flight status sharing data;

FIG. 7 shows an example of a communication method for an unmanned aircraft system;

FIG. 8 and FIG. 9 show an example of a communication method for an unmanned aircraft system; and

FIG. 10 shows an example of a computing system.

### DETAILED DESCRIPTION

Hereinafter, some examples of the present disclosure will be described in detail with reference to the exemplary drawings. In adding the reference numerals to the components of each drawing, it should be noted that the identical component is designated by the identical numerals even when they are displayed on other drawings. Further, in describing the example of the present disclosure, a detailed description of well-known features or functions will be ruled out in order not to unnecessarily obscure the gist of the present disclosure.

In describing the components of the example of the present disclosure, terms such as first, second, “A”, “B”, (a), (b), and the like may be used. These terms are only used to distinguish one component from another component, but do not limit the corresponding components irrespective of the order or priority of the corresponding components. Furthermore, unless otherwise defined, all terms including technical and scientific terms used herein have the same meaning as being generally understood by those skilled in the art to which the present disclosure pertains. Such terms as those defined in a generally used dictionary are to be interpreted as having meanings equal to the contextual meanings in the relevant field of art, and are not to be interpreted as having ideal or excessively formal meanings unless clearly defined as having such in the present application.

For purposes of this application and the claims, using the exemplary phrase “at least one of: A; B; or C” or “at least one of A, B, or C,” the phrase means “at least one A, or at least one B, or at least one C, or any combination of at least one A, at least one B, and at least one C. Further, exemplary phrases, such as “A, B, or C”, “at least one of A, B, and C”, “at least one of A, B, or C”, etc. as used herein may mean each listed item or all possible combinations of the listed items. For example, “at least one of A or B” may refer to (1) at least one A; (2) at least one B; or (3) at least one A and at least one B.

The term “module” or “unit” used in the specification means a software and/or hardware component, and the “module” or “unit” performs certain operations/functions/roles. However, the “module” or “unit” is not construed as being limited to software or hardware. The “module” or “unit” may be configured to be in an addressable storage medium or to execute one or more processors. Therefore, as an example, the “module” or “unit” may include at least one of components such as software components, object-oriented software components, class components, and task components, processes, functions, attributes, procedures, sub-routines, segments of program codes, drivers, firmware, micro-codes, circuits, data, databases, data structures, tables, arrays, or variables. Functions provided in the components, “modules”, or “units” may be combined into a smaller number of components, “modules”, or “units” or further divided into additional components, “modules”, or “units”.

In the present disclosure, the “module” or “unit” may be realized as a processor and a memory. The “processor” should be widely construed to include a general-purpose processor, a central processing unit (CPU), a microprocessor, a digital signal processor (DSP), a microcontroller, a state machine, or the like. In some environments, the “processor” may refer to an application-specific integrated circuit (ASIC), a programmable logic device (PLD), or a field-programmable gate array (FPGA), and the like. For example, the “processor” may refer to a combination of processing devices such as a combination of a DSP and a microprocessor, a combination of a plurality of microprocessors, a combination of one or more microprocessors combined with a DSP core, or any other such combination. Moreover, the “memory” should be widely construed to include any electronic component capable of storing electronic information. The “memory” may refer to various types of processor-readable medium such as a random access memory (RAM), a read only memory (ROM), a non-volatile random access memory (NVRAM), a programmable read only memory (PROM), an erasable programmable read only memory (EPROM), an electrically erasable programmable read only memory (EEPROM), a flash memory, a magnetic or optical data storage device, and registers. When the processor can read information from a memory and/or record the information in the memory, the memory may be in a state of electronic communication with a processor. Memory integrated into a processor is in a state of electronic communication with the processor.

The one or more features described herein may be provided as a computer program stored in a computer-readable recording medium in order to be executed on a computer. The medium may either continuously store a computer-executable program or temporarily store the program for execution or download. Furthermore, the medium may be a variety of recording or storage means in the form of a single hardware device or multiple combined hardware devices, and is not limited to media directly connected to some computer system but may also be distributed across a network. Examples of such media include magnetic media such as a hard disk, a floppy disk, or a magnetic tape, optical recording media such as a CD-ROM or a DVD, magneto-optical media such as a floptical disk, and a ROM, RAM, or flash memory, among others, configured to store program instructions. Additional examples of such media include media or storage media that are managed by an app store that distributes applications or by various other sites or servers that provide or distribute software.

In a hardware implementation, processing units used for performing the techniques may be implemented within one or more ASICs, DSPs, digital signal processing devices, programmable logic devices, field-programmable gate arrays, processors, controllers, microcontrollers, microprocessors, electronic devices, or computers or combinations thereof designed to perform the functions described in the present disclosure.

An automation level of an autonomous driving vehicle may be classified as follows, according to the American Society of Automotive Engineers (SAE). At autonomous driving level 0, the SAE classification standard may correspond to “no automation,” in which an autonomous driving system is temporarily involved in emergency situations (e.g., automatic emergency braking) and/or provides warnings only (e.g., blind spot warning, lane departure warning, etc.), and a driver is expected to operate the vehicle. At autonomous driving level 1, the SAE classification standard may correspond to “driver assistance,” in which the system performs some driving functions (e.g., steering, acceleration, brake, lane centering, adaptive cruise control, etc.) while the driver operates the vehicle in a normal operation section, and the driver is expected to determine an operation state and/or timing of the system, perform other driving functions, and cope with (e.g., resolve) emergency situations. At autonomous driving level 2, the SAE classification standard may correspond to “partial automation,” in which the system performs steering, acceleration, and/or braking under the supervision of the driver, and the driver is expected to determine an operation state and/or timing of the system, perform other driving functions, and cope with (e.g., resolve) emergency situations. At autonomous driving level 3, the SAE classification standard may correspond to “conditional automation,” in which the system drives the vehicle (e.g., performs driving functions such as steering, acceleration, and/or braking) under limited conditions but transfer driving control to the driver when the required conditions are not met, and the driver is expected to determine an operation state and/or timing of the system, and take over control in emergency situations but do not otherwise operate the vehicle (e.g., steer, accelerate, and/or brake). At autonomous driving level 4, the SAE classification standard may correspond to “high automation,” in which the system performs all driving functions, and the driver is expected to take control of the vehicle only in emergency situations. At autonomous driving level 5, the SAE classification standard may correspond to “full automation,” in which the system performs full driving functions without any aid from the driver including in emergency situations, and the driver is not expected to perform any driving functions other than determining the operating state of the system. Although the present disclosure may apply the SAE classification standard for autonomous driving classification, other classification methods and/or algorithms may be used in one or more configurations described herein.

One or more features associated with autonomous driving control may be activated based on configured autonomous driving control setting(s) (e.g., based on at least one of: an autonomous driving classification, a selection of an autonomous driving level for a vehicle, etc.). Based on one or more features (e.g., features of communication link monitoring, broadcasting link status, and terrestrial command relay for the vehicle) described herein, an operation of the vehicle may be controlled. The vehicle control may include various operational controls associated with the vehicle (e.g., autonomous driving control, sensor control, braking control, braking time control, acceleration control, acceleration change rate control, alarm timing control, forward collision warning time control, etc.).

One or more auxiliary devices (e.g., engine brake, exhaust brake, hydraulic retarder, electric retarder, regenerative brake, etc.) may also be controlled, for example, based on one or more features (e.g., features of communication link monitoring, broadcasting link status, and terrestrial command relay for the vehicle) described herein.

One or more communication devices (e.g., a modem, a network adapter, a radio transceiver, an antenna, etc., that is capable of communicating via one or more wired or wireless communication protocols, such as Ethernet, Wi-Fi, near-field communication (NFC), Bluetooth, Long-Term Evolution (LTE), 5G New Radio (NR), vehicle-to-everything (V2X), etc.) may also be controlled, for example, based on one or more features (e.g., features of communication link monitoring, broadcasting link status, and terrestrial command relay for the vehicle) described herein.

Minimum risk maneuver (MRM) operation(s) may also be controlled, for example, based on one or more features (e.g., features of communication link monitoring, broadcasting link status, and terrestrial command relay for the vehicle) described herein. A minimal risk maneuvering operation (e.g., a minimal risk maneuver, a minimum risk maneuver) may be a maneuvering operation of a vehicle to minimize (e.g., reduce) a risk of collision with surrounding vehicles in order to reach a lowered (e.g., minimum) risk state. A minimal risk maneuver may be an operation that may be activated during autonomous driving of the vehicle when a driver is unable to respond to a request to intervene. During the minimal risk maneuver, one or more processors of the vehicle may control a driving operation of the vehicle for a set period of time.

Biased driving operation(s) may also be controlled, for example, based on one or more features (e.g., features of communication link monitoring, broadcasting link status, and terrestrial command relay for the vehicle) described herein. A driving control apparatus may perform a biased driving control. To perform a biased driving, the driving control apparatus may control the vehicle to drive in a lane by maintaining a lateral distance between the position of the center of the vehicle and the center of the lane. For example, the driving control apparatus may control the vehicle to stay in the lane but not in the center of the lane. The driving control apparatus may identify or determine a biased target lateral distance for biased driving control. For example, a biased target lateral distance may comprise an intentionally adjusted lateral distance that a vehicle may aim to maintain from a reference point, such as the center of a lane or another vehicle, during maneuvers such as lane changes. This adjustment may be made to improve the vehicle's stability, safety, and/or performance under varying driving conditions, etc. For example, during a lane change, the driving control system may bias the lateral distance to keep a safer gap from adjacent vehicles, considering factors such as the vehicle's speed, road conditions, and/or the presence of obstacles, etc.

One or more sensors (e.g., IMU sensors, camera, LIDAR, RADAR, blind spot monitoring sensor, line departure warning sensor, parking sensor, light sensor, rain sensor, traction control sensor, anti-lock braking system sensor, tire pressure monitoring sensor, seatbelt sensor, airbag sensor, fuel sensor, emission sensor, throttle position sensor, inverter, converter, motor controller, power distribution unit, high-voltage wiring and connectors, auxiliary power modules, charging interface, etc.) may also be controlled, for example, based on one or more features (e.g., features of communication link monitoring, broadcasting link status, and terrestrial command relay for the vehicle) described herein. An operation control for autonomous driving of the vehicle may include various driving control of the vehicle by the vehicle control device (e.g., acceleration, deceleration, steering control, gear shifting control, braking system control, traction control, stability control, cruise control, lane keeping assist control, collision avoidance system control, emergency brake assistance control, traffic sign recognition control, adaptive headlight control, etc.).

An autonomous driving level and/or autonomous driving activation/deactivation may also be controlled, for example, based on one or more features (e.g., features of communication link monitoring, broadcasting link status, and terrestrial command relay for the vehicle) described herein. A driving control apparatus may perform an autonomous driving level control (e.g., a change of an autonomous driving level, a change of a required user attentiveness, etc.) or cause deactivation of an autonomous driving operation. For example, by changing the required user attentiveness, the driver may be required to place his/her hands on the driving wheel more often (e.g., at least once in a threshold time period, such as five second, 30 seconds, 1 minute, etc.). By changing the required user attentiveness, the driver may be required to look ahead more often (e.g., at least once in a threshold time period, such as five second, 30 seconds, 1 minute, etc.). By changing the autonomous driving level, one or more video contents may not be displayed on a display of the vehicle.

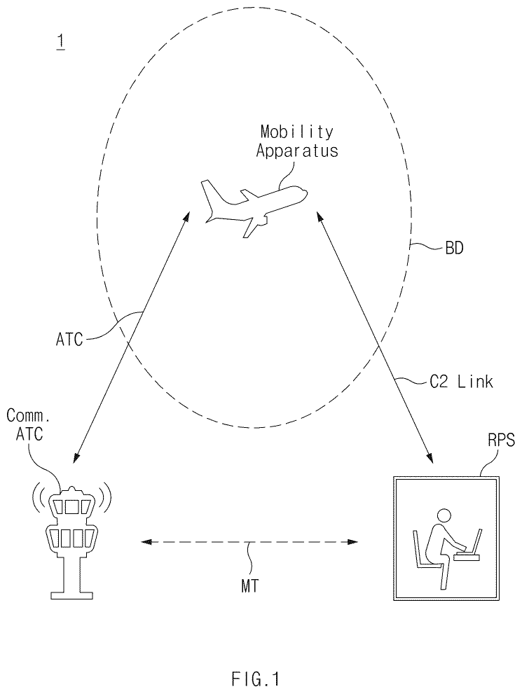

Hereinafter, examples of the present disclosure will be described in detail with reference to FIGS. 1 to 10.

The subject matter relates to making unmanned vehicle systems, such as drones, safer and more reliable by improving how they communicate with pilots (e.g., a remote pilot station) and a control server (e.g., air traffic controllers). Unmanned aircraft systems may use wireless links to exchange commands and data, but these links may fail due to interference, malicious activity, or adverse weather conditions, which may create hazardous situations. The described system addresses this by continuously monitoring the integrity of multiple communication links between the unmanned vehicle, the remote pilot station, and the control server. Upon detecting degradation or total loss of these links, the unmanned vehicle system automatically switches to backup communication methods, such as broadcasting status information to nearby receivers and using ground-based networks (e.g., 4G/5G), to ensure that critical data may still be transmitted. This approach enables the unmanned vehicle, the pilot, and the control server to remain connected and informed even if primary links fail, thereby enhancing safety and operational efficiency of the unmanned vehicle.

FIG. 1 shows an example of an unmanned aircraft system 1 according to an example of the present disclosure.

Referring to FIG. 1, the unmanned aircraft system 1 may include a mobility apparatus (e.g., a remotely piloted aircraft (RPA), an unmanned aerial vehicle (UAV), a quadcopter, or a fixed-wing drone, etc.), a remote pilot station RPS, an air traffic control ATC, and a communication link. Herein, the communication link may include a C2 link C2 Link, air traffic control communication ATC Comm, terrestrial communication MT, and broadcast communication BD.

The mobility apparatus, the remote pilot station RPS and the air traffic control ATC may transmit and receive data using the respective communication links. Thus, it is assumed that each of the mobility apparatus, the remote pilot station RPS, and the air traffic control ATC includes a communication module for supporting the communication link (e.g., a radio transceiver, satellite modem, or optical communication terminal, etc.).

The C2 link C2 Link may refer to a wireless communication link between the mobility apparatus and the remote pilot station RPS. The C2 link C2 Link may be a data link with a predetermined frequency band (e.g., in the MHz or GHz range), which may be composed of at least one multi-link (e.g., redundant parallel channels, frequency diversity links, or time-division multiplexed paths, etc.). The C2 link C2 Link is assumed to be a communication link which is preset in the unmanned aircraft system 1 or is authorized for use by the unmanned aircraft system 1.

The remote pilot station RPS may select an optimal C2 link among at least one C2 link and may communicate with the mobility apparatus. For example, the C2 link C2 Link may include ultra-high frequency (UHF) communication, a C-band, L-band communication, or mobile telecommunication (e.g., LTE, 5G NR, or satellite-based mobile service, etc.).

The C2 link C2 Link may include a telecommand (TC) link and a telemetry (TM) link. Herein, the TC link is an up link for delivering flight trajectory control information, all pieces of control information of the unmanned aircraft system 1 (e.g., navigation commands, payload operation commands, or contingency procedure instructions, etc.), which are required for safety of flight, and the like from a terrestrial pilot, that is, the remote pilot station RPS, to the mobility apparatus. The TM link is a down link for delivering status data such as a position of the mobility apparatus, an altitude of the mobility apparatus, a speed of the mobility apparatus, UAS operation mode and state information, navigation aid data, detection and avoidance-related tracking information, meteorological radar information, and image information (e.g., real-time video, infrared imagery, or LiDAR point cloud data, etc.) from the mobility apparatus to the terrestrial remote pilot station RPS.

The air traffic control communication ATC Comm may refer to a wireless communication link between the mobility apparatus and the air traffic control ATC. For example, the air traffic control communication ATC Comm may include VHF communication using a frequency in the 100-150 MHz band (e.g., 118-137 MHz for civil aviation voice, or 136-144 MHz for certain data link services, etc.).

The terrestrial communication MT may be a wireless communication link or a wired communication link between the remote pilot station RPS and the air traffic control ATC. The terrestrial communication MT may include mobile telecommunication. The mobile telecommunication may include 4th generation (4G), 5th generation (5G), and 6th generation (6G) networks (e.g., LTE, 5G NR Standalone, or future ultra-low latency networks, etc.). However, the terrestrial communication MT is not limited to the mobile telecommunication, which may include communication in which the remote pilot station RPS and the air traffic control ATC are directly connected with each other (e.g., via a dedicated fiber optic line or microwave backhaul link, etc.) and communication in which the remote pilot station RPS and the air traffic control ATC are connected via an intermediate server (e.g., a cloud-based air traffic management platform, or a secure data relay node, etc.).

Furthermore, the terrestrial communication MT may transmit and receive both a voice and data between the air traffic control ATC and the remote pilot station RPS via the mobility apparatus. For example, the remote pilot station RPS may transmit a voice and data signals (e.g., pilot position reports, weather updates, or airspace clearance requests, etc.) to the mobility apparatus via the C2 link C2 Link. Thereafter, the mobility apparatus may transmit the received voice and data to the air traffic control ATC via the air traffic control communication ATC Comm. On the other hand, as in the above-mentioned process, the air traffic control ATC may transmit the voice and data (e.g., landing instructions, flight plan amendments, or traffic advisories, etc.) to the mobility apparatus via the air traffic control communication ATC Comm. Thereafter, the mobility apparatus may transmit the received voice and data to the remote pilot station RPS via the C2 link C2 Link.

As an example, in a normal case in which a loss does not occur in the C2 link C2 Link, the remote pilot station RPS and the air traffic control ATC may communicate with each other via the mobility apparatus (e.g., relaying both voice and telemetry without delay). On the other hand, if a loss occurs in the C2 link C2 Link, the remote pilot station RPS and the air traffic control ATC may communicate with each other via the terrestrial communication MT (e.g., through a 5G network, a dedicated leased line, or a secure satellite gateway, etc.). Thus, although the loss occurs in the C2 link C2 Link, it is possible for the mobility apparatus, the remote pilot station RPS, and the air traffic control ATC to communicate with each other.

Simultaneously, if the loss occurs in the C2 link C2 Link, the mobility apparatus may perform the broadcast communication BD. Herein, the broadcast communication BD may be a one-to-many communication scheme (e.g., simultaneous transmission to multiple ground stations, other aircraft, or networked receivers, etc.). The mobility apparatus may simultaneously transmit the same data to the remote pilot station RPS and the air traffic control ATC, and optionally to other nearby aircraft, which support a broadcast communication link. Thus, although the loss occurs in the C2 link C2 Link, the broadcast communication BD may notify the mobility apparatus, the remote pilot station RPS, and the air traffic control ATC of a status of the C2 link C2 Link. Herein, the broadcast communication BD may support automatic dependent surveillance-broadcast (ADS-B). The ADS-B is a mobility apparatus surveillance system for automatically broadcasting mobility apparatus surveillance information (e.g., current position, altitude, velocity, and identification code, etc.) to the terrestrial air traffic control ATC and another mobility apparatus at a certain period using a satellite navigation system and the 1.090 MHz transmission link.

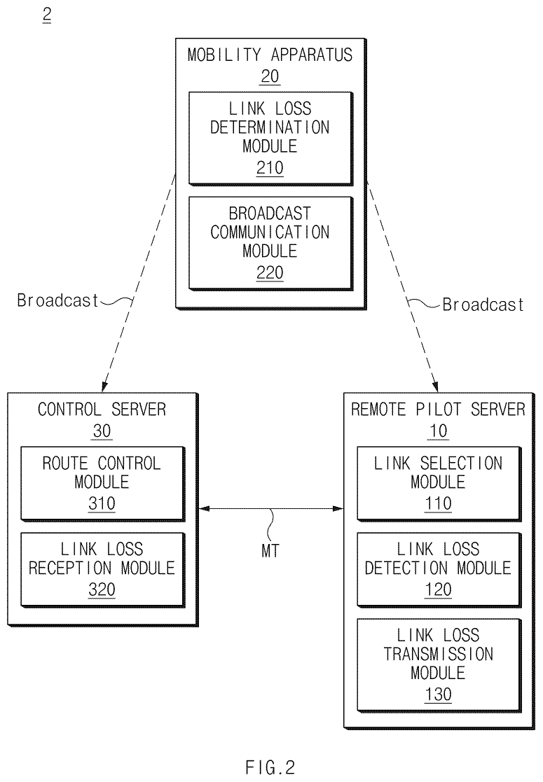

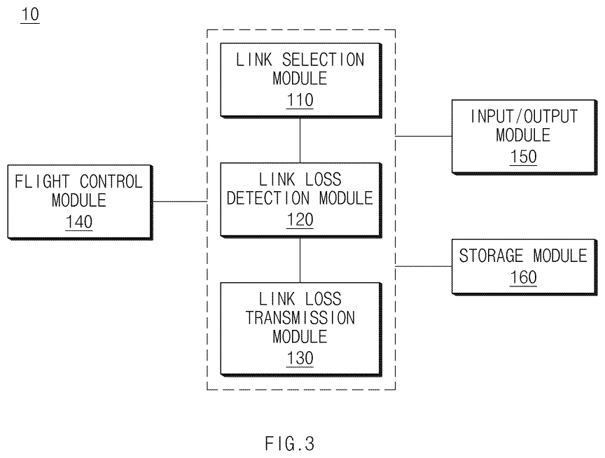

FIG. 2 shows an example of a configuration of a communication system 2 for an unmanned aircraft system 1 according to an example of the present disclosure. FIG. 3 shows an example of a configuration of a remote pilot server 10 according to an example of the present disclosure.

Referring to FIG. 2 and FIG. 3, the communication system 2 may include the remote pilot server 10, a mobility apparatus 20, and a control server 30. Herein, the remote pilot server 10 may be a server provided in a remote pilot station RPS. The control server 30 may be a server provide in air traffic control ATC. Each of the remote pilot server 10 and the control server 30 may include a communication module for supporting the above-mentioned communication link (e.g., modules for C2 communication, ATC communication, terrestrial data transfer, or broadcast reception, etc.).

The remote pilot server 10 may communicate with the mobility apparatus 20 via at least one link to control flight of the mobility apparatus 20. Herein, the at least one link may include a C2 link C2 Link (e.g., primary UHF link or secondary satellite link, etc.).

The remote pilot server 10 may include a link selection module 110, a link loss detection module 120, a link loss transmission module 130, a flight control module 140, an input/output module 150, and a storage module 160. Herein, the link selection module 110, the link loss detection module 120, and the link loss transmission module 130 may be included in a communication module of the remote pilot server 10 (e.g., integrated as software-defined radio functions, FPGA-based network processors, or dedicated avionics communication hardware, etc.).

The link selection module 110 may select at least one link to communicate with the mobility apparatus 20. For example, the link selection module 110 may select first to third links and may transmit data for the selected link to the mobility apparatus 20. Thereafter, the mobility apparatus 20 may perform communication with the remote pilot server 10, until flight operation ends, via the selected link. Herein, each of the first to third links may perform communication in a specific frequency band (e.g., UHF, C-band, or Ku-band, etc.) and the same data packet may be transmitted and received in each of the first to third links (e.g., for redundancy, latency comparison, or error detection, etc.).

The link selection module 110 may assign a priority to the at least one link. For example, the link selection module 110 may set the first to third links to a first priority, may set a fourth link to a second priority, and may set a fifth link to a third priority. Thus, if the link selection module 110 selects the at least one link to communicate with the mobility apparatus 20, the at least one link may be selected based on a priority (e.g., favoring the lowest-latency or highest-throughput channel first, then falling back to a higher-latency backup, etc.).

The link loss detection module 120 may detect a loss in the at least one link. For example, the link loss detection module 120 may receive link status data (e.g., signal-to-noise ratio, packet loss rate, or connectivity status flag, etc.) capable of knowing whether the loss occurs in the at least one link from the mobility apparatus 20. The link loss detection module 120 may detect that the loss occurs in the at least one link based on the received link status data. For example, the mobility apparatus 20 may determine that the loss occurs in all the first to third links and may transmit link status data of each of the first to third links to the link loss detection module 120. Herein, the link status data of each of the first to third links may be received in the link loss detection module 120 via the link. Thereafter, the link loss detection module 120 may transmit the link status data to the link selection module 110. The link selection module 110 may reselect the fourth link set to the second priority. Thereafter, the link selection module 110 may transmit data for the fourth link to the mobility apparatus 20. The mobility apparatus 20 may communicate with the remote pilot server 10 via the fourth link (e.g., a terrestrial LTE/5G connection or a satellite-based secondary channel, etc.).

The link loss detection module 120 may generate a notification signal including the link status data based on the detected result. For example, if it is detected that the loss occurs in all the links capable of communicating with the mobility apparatus 20, the link loss detection module 120 may generate the notification signal including the link status data. For another example, the link loss detection module 120 may receive a notification that the loss occurs in all the links, the link status data, and flight status sharing data (e.g., GPS position, heading, or current flight mode, etc.) via broadcast communication from the mobility apparatus 20. Thereafter, the link loss detection module 120 may generate the notification signal including the link status data.

Thereafter, the link loss transmission module 130 may transmit the notification signal to the control server 30 via terrestrial communication MT (e.g., a secure fiber-optic connection, microwave backhaul, or encrypted VPN tunnel over a public network, etc.).

The flight control module 140 may generate flight trajectory control information, all pieces of control information of an unmanned aircraft system 1 (e.g., waypoint updates, altitude changes, or return-to-home commands, etc.), which are required for safety of flight, a signal controlled by a terrestrial pilot, or the like.

The input/output module 150 may receive a control signal from the pilot (e.g., joystick movement, throttle adjustment, or camera gimbal control, etc.) and may output a flight status of the mobility apparatus 20 (e.g., current altitude, battery level, or system warnings, etc.) to the pilot.

The storage module 160 may store the received link status data and the received flight status sharing data (e.g., for historical link performance analysis or incident investigation, etc.). The storage module 160 may store all pieces of data performed by the remote pilot server 10, as well as the received data.

The storage module 160 may constitute a plurality of data slots and may additionally store the received link status data and the received flight status sharing data in an open data slot (e.g., overwriting the oldest slot when memory is full, or reserving slots for high-priority emergency data, etc.).

The mobility apparatus 20 may include a link loss determination module 210 and a broadcast communication module 220 (e.g., implemented as separate hardware boards, integrated software routines, or programmable logic circuits, etc.).

The link loss determination module 210 may determine whether a loss occurs based on a plurality of data packets received in the at least one link. For example, the link loss determination module 210 may receive a data packet with a certain transmission speed via the first to third links (e.g., from ground control commands, telemetry updates, or sensor data streams, etc.). Thereafter, the link loss determination module 210 may calculate the number of normal data packets during a certain time among the plurality of data packets (e.g., a 1-second monitoring interval or a rolling 500 ms detection window, etc.).

Herein, the link loss determination module 210 may determine a data packet, integrity of which is verified by a checksum, among the plurality of data packets as the normal data packet. Alternatively, the link loss determination module 210 may determine a data packet, integrity of which is verified by a cyclic redundancy code (CRC), among the plurality of data packets as the normal data packet (e.g., CRC-16, CRC-32, or other standardized error-detection codes, etc.). In other words, the normal data packet may refer to a data packet received that confirms to a predetermined interface format (e.g., fixed-length header, defined field order, or expected byte alignment, etc.). At this time, the normal data packet may be assigned a value of “1” as the link status value.

On the other hand, an abnormal data packet may be a data packet, integrity of which is not verified by the checksum, among the plurality of data packets. In other words, the abnormal data packet may refer to a data packet that is missing during the certain time and may refer to a data packet that fails to confirm the predetermined interface format (e.g., corrupted payload, incomplete frame, or invalid control field, etc.). At this time, the abnormal data packet may be assigned a value of “0” as the link status value.

Thereafter, the link loss determination module 210 may calculate a ratio of the normal data packets to the plurality of data packets during the certain time. For example, the link loss determination module 210 may calculate the number of normal data packets during the certain time. Herein, it is assumed that the number of the plurality of data packets is N and the number of the normal data packets is A. In other words, it is assumed that a link status array size is N. This may change with regard to an execution period and a data transmission and reception period of the communication system 2 (e.g., different array sizes for high-rate sensor feeds vs. low-rate control channels, etc.). The link loss determination module 210 may use the following equation to calculate the ratio of the normal data packets to the plurality of data packets: (A/N)×100=Y (%).

The link loss determination module 210 may generate link status data based on the calculated result. For example, if the calculated Y is greater than or equal to the threshold X, the link loss determination module 210 may determine that the loss does not occur in the at least one link. In other words, if Y1 calculated in the first link is greater than or equal to the threshold X, the link loss determination module 210 may determine the first link as a normal link. On the other hand, if the calculated Y is less than the threshold X, the link loss determination module 210 may determine that the loss occurs in the at least one link. In other words, if Y3 calculated in the third link is less than the threshold X, the third link may be determined as a link in which the loss occurs. Herein, the threshold X may be a value preset via an experiment (e.g., lab simulation under interference, real-flight test over varying distances, or stress testing in adverse weather, etc.).

The link loss determination module 210 may transmit the link status data generated based on the determined result to the link loss detection module 120 of the remote pilot server 10. Herein, the link status data may include a link status value for the at least one link, the calculated result, and the determined result (e.g., binary health flag, numeric packet integrity ratio, and textual fault code, etc.). For example, if determining that the first link is normal and determining that the loss occurs in the third link, the link loss determination module 210 may transmit link status data including information about it to the link loss detection module 120. Thereafter, the link loss detection module 120 may transmit the received link status data to the link selection module 110. The link selection module 110 may release the selection of the third link and may maintain the first link. For another example, if determining that the loss occurs in all the first to third links, the link loss determination module 210 may transmit link status data including information about it to the link loss detection module 120. Thereafter, the link selection module 110 may reselect the fourth link set to the second priority (e.g., a high-latency satellite backup or a terrestrial LTE failover channel, etc.) depending on the above-mentioned process.

The broadcast communication module 220 may transmit the flight status sharing data via broadcast communication based on the determined result of the link loss determination module 210. Herein, the flight status sharing data may include an identification (ID) of the mobility apparatus, a type of the mobility apparatus, a departure place and time, an arrival place and time, flight route data including GPS coordinates, an air traffic control (ATC) area, a current flight status, or additional mission-related information (e.g., onboard payload type, fuel/battery level, or weather conditions at waypoints, etc.).

If determining that the loss occurs in all the at least one link, the link loss determination module 210 may transmit the determined result to the broadcast communication module 220. In other words, if the loss occurs in all the links, communication between the mobility apparatus 20 and the remote pilot server 10 may be impossible or unstable. Thus, the broadcast communication module 220 may transmit the flight status sharing data and the link status data to the remote pilot server 10 and the control server 30 via broadcast communication. Herein, each of the remote pilot server 10 and the control server 30 may include a communication module for supporting the broadcast communication (e.g., ADS-B transceiver, satellite broadcast receiver, or VHF data broadcast module, etc.). At this time, the transmitted flight status sharing data may include a flight status at a time point when the loss does not occur in the at least one link, rather than the current flight status (e.g., last known heading, speed, and altitude before link loss, etc.).

Furthermore, if the link loss determination module 210 determines that the loss occurs in all the links, a control module of the mobility apparatus 20 may control to perform a predetermined procedure. For example, the predetermined procedure may include return to home (RTH) or auto landing (e.g., landing at a nearest safe location, holding hover position until link recovery, or diverting to an alternate landing site, etc.). Thus, if it is determined that the loss occurs in all the links, the mobility apparatus 20 may perform RTH or auto landing depending on the predetermined procedure. Simultaneously, the control module may provide a notification that the loss has occurred in all the links using a visual output module and an audible output module provided in the mobility apparatus 20 (e.g., flashing LEDs, warning siren, or cockpit display alert, etc.). In other words, the mobility apparatus 20 may provide the notification that the loss has occurred in all the links via the visual output module and the audible output module, as well as broadcast communication.

The control server 30 may include a route control module 310 and a link loss reception module 320 (e.g., implemented as independent processors, shared software services, or distributed computing nodes, etc.).

The route control module 310 may determine whether the mobility apparatus 20 flies along a predetermined flight route. For example, the route control module 310 may receive current location data of the mobility apparatus 20 (e.g., GPS position, altitude, or heading from onboard sensors, etc.) to track a flight route of the mobility apparatus 20. The route control module 310 may determine whether the mobility apparatus 20 normally flies along the predetermined flight route based on the tracked result (e.g., checking for deviations beyond a preset corridor or altitude band, etc.).

The route control module 310 may generate a command signal for the flight route via air traffic control (ATC) communication. For example, if the mobility apparatus 20 deviates from the predetermined flight route, the route control module 310 may transmit the command signal to the mobility apparatus 20 via the ATC communication (e.g., instructing course correction, altitude change, or emergency landing, etc.). Thereafter, the mobility apparatus 20 may transmit the received command signal to the remote pilot server 10 via the at least one link.

The link loss reception module 320 may receive a notification signal including link status data via terrestrial communication MT. For example, if the loss occurs in all the at least one link, the link loss reception module 320 may receive the link status data from the link loss transmission module 130 of the remote pilot server 10 via terrestrial communication MT (e.g., 4G LTE, 5G NR, or dedicated fiber-optic link, etc.). Simultaneously, if the loss occurs in all the at least one link, the link loss reception module 320 may transmit the command signal to the link loss transmission module 130. Herein, the command signal generated by the route control module 310 may be a command signal for a mission which should be performed by the mobility apparatus 20, when the at least one link is normalized (e.g., resume mapping mission, continue cargo delivery, or start inspection task, etc.). Thereafter, if the at least one link is normalized, the remote pilot server 10 may immediately control flight of the mobility apparatus 20 based on the received command signal. Although the loss occurs in all the links in an airspace where control is required via the above-mentioned process, the control server 30 may avoid or cope with a risk situation in which a plurality of mobility apparatus collide with each other (e.g., rerouting multiple units to different altitudes or paths, etc.).

As described above, the communication system 2 for the unmanned aircraft system according to the present disclosure may respond to the occurrence of the loss in the communication link (e.g., primary wireless link, broadcast link, or ATC link, etc.) to improve flight operation and stability of the unmanned aircraft system. Furthermore, although the loss occurs in the communication link, the communication system 2 is able to communicate with the mobility apparatus, the remote pilot station, and the air traffic control (e.g., via alternative terrestrial or satellite networks, etc.), thus improving reliability of flight operation. Furthermore, if the loss occurs in the communication link, the communication system 2 may use an existing terrestrial communication network (e.g., public 4G/5G/6G cellular, wired fiber backhaul, or microwave relay, etc.) to reduce the cost of constructing an infrastructure.

In addition, if the loss occurs in the communication link when operating general aviation or advanced air mobility (AAM), the communication system 2 according to the present disclosure may be applied. Thus, the communication system 2 may improve the efficiency of flight operation for the general aviation or the AAM (e.g., passenger drones, cargo eVTOLs, or medical emergency aircraft, etc.).

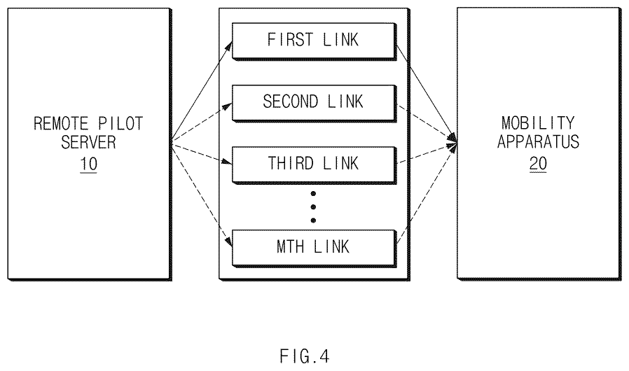

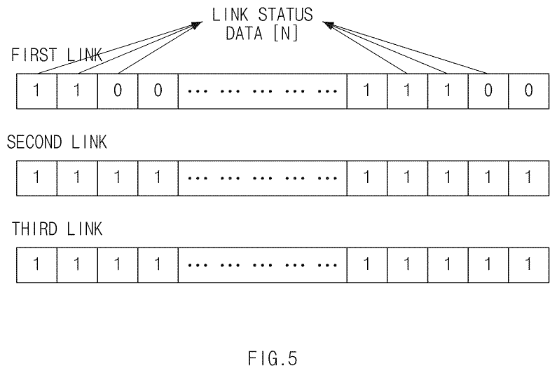

FIG. 4 is an example of a communication link according to an example of the present disclosure. FIG. 5 is an example of link status data according to an example of the present disclosure.

Referring to FIG. 4, the communication link may refer to a wireless communication link between a mobility apparatus and a remote pilot station RPS. The communication link may be a data link with a predetermined frequency band Hz (e.g., C-band, UHF, or L-band, etc.), which may be composed of at least one multi-link. It is assumed that the communication link is a communication link preset in an unmanned aircraft system or is authorized from the unmanned aircraft system (e.g., certified by aviation authorities or assigned by network management systems, etc.).

For example, a link selection module 110 of a remote pilot server 10 may select first to third links and may transmit data for the selected link to a mobility apparatus 20. Thereafter, the mobility apparatus 20 may perform communication with the remote pilot server 10, until flight operation ends, via the selected link. Herein, each of the first to third links may perform communication in a specific frequency band (e.g., first link in C-band, second link in L-band, and third link in UHF, etc.). The same data packet may be transmitted and received in each of the first to third links (e.g., redundancy for fault tolerance, etc.).

Referring to FIG. 5, a link loss determination module 210 of the mobility apparatus 20 may determine whether a loss occurs based on a plurality of data packets received in at least one link. For example, the link loss determination module 210 may receive a data packet with a certain transmission speed via the first to third links (e.g., 5 Mbps, 10 Mbps, or 50 Mbps, etc.). Thereafter, the link loss determination module 210 may calculate the number of normal data packets during a certain time among the plurality of data packets (e.g., within a 1-second, 5-second, or 10-second observation window, etc.).

Herein, the link loss determination module 210 may determine a data packet, integrity of which is verified by a checksum, among the plurality of data packets as the normal data packet. Alternatively, the link loss determination module 210 may determine a data packet, integrity of which is verified by a cyclic redundancy code (CRC), among the plurality of data packets as the normal data packet. In other words, the normal data packet may refer to a data packet received to suit a predetermined interface format (e.g., matching expected packet header structure or payload size, etc.). At this time, the normal data packet may be assigned a value of “1” as the link status value.

On the other hand, an abnormal data packet may be a data packet, integrity of which is not verified by the checksum, among the plurality of data packets. In other words, the abnormal data packet may refer to a data packet which is not received during the certain time (e.g., missing due to packet drop or timeout, etc.) and may refer to a data packet which is received not to suit the predetermined interface format (e.g., corrupted header or incorrect payload size, etc.). At this time, the abnormal data packet may be assigned a value of “0” as the link status value.

Thereafter, the link loss determination module 210 may calculate a ratio of the normal data packets to the plurality of data packets during the certain time. The link loss determination module 210 may use the following equation to calculate the ratio of the normal data packets to the plurality of data packets: (A/N)×100=Y (%). Herein, the number of the plurality of data packets is denoted as N and the number of the normal data packets is denoted as A (e.g., N=100 total packets, A=95 normal packets, Y=95%, etc.).

Thereafter, the link loss determination module 210 may generate link status data based on the calculated result. For example, if the calculated Y is greater than or equal to a threshold X, the link loss determination module 210 may determine that the loss does not occur in the at least one link (e.g., maintaining stable C-band or UHF connectivity, etc.). In other words, if Y1 calculated in the first link is greater than or equal to the threshold X, the link loss determination module 210 may determine the first link as a normal link. On the other hand, if the calculated Y is less than the threshold X, the link loss determination module 210 may determine that the loss occurs in the at least one link (e.g., excessive packet loss or signal degradation below minimum operational level, etc.). In other words, if Y3 calculated in the third link is less than the threshold X, the third link may be determined as a link in which the loss occurs.

Thereafter, the link loss determination module 210 may transmit the link status data generated based on the determined result to a link loss detection module 120 of the remote pilot server 10. Herein, the link status data may include a link status value for the at least one link, the calculated result, and the determined result (e.g., “Link 1: normal, Link 3: failed,” etc.).

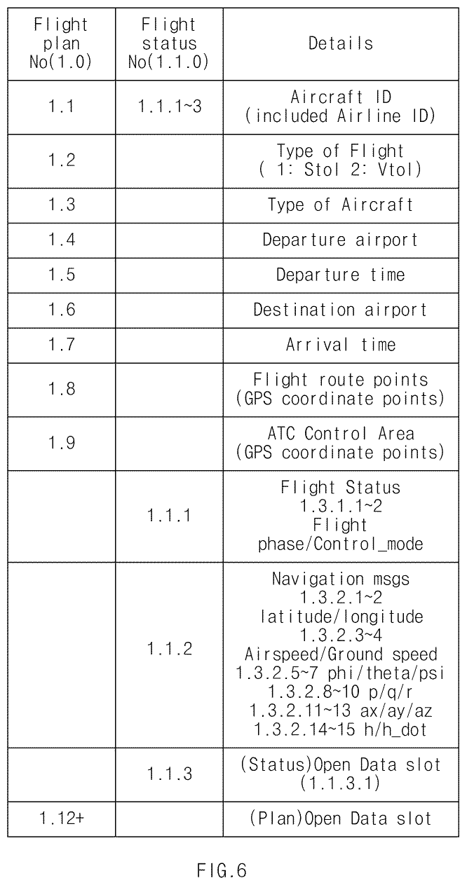

FIG. 6 is an example of flight status sharing data according to an example of the present disclosure.

Referring to FIG. 6, a broadcast communication module 220 may transmit flight status sharing data via broadcast communication based on the determined result of a link loss determination module 210. Herein, the flight status sharing data may include an identification (ID) of a mobility apparatus, a type of the mobility apparatus, a departure place and time, an arrival place and time, flight route data including GPS coordinates, an air traffic control (ATC) area, a current flight status, or the like (e.g., altitude, speed, heading, fuel level, or onboard system status, etc.).

If determining that a loss occurs in all at least one link, the link loss determination module 210 may transmit the determined result to the broadcast communication module 220. In other words, if the loss occurs in all the links, communication between a mobility apparatus 20 and a remote pilot server 10 may be impossible or unstable (e.g., due to jamming, terrain blockage, or hardware failure, etc.). Thus, the broadcast communication module 220 may transmit the flight status sharing data and link status data to the remote pilot server 10 and a control server 30 via broadcast communication. Herein, each of the remote pilot server 10 and the control server 30 may include a communication module for supporting the broadcast communication (e.g., ADS-B or other one-to-many wireless protocols, etc.). At this time, flight status Nos 1.1.1 and 1.1.2 of FIG. 6 among the transmitted pieces of flight status sharing data may include a flight status at a time point when the loss does not occur in the at least one link, rather than a current flight status. Furthermore, flight plan No 1.8 of FIG. 6 among the pieces of flight status sharing data may include flight route data including GPS coordinates for a predetermined flight route (e.g., waypoints, alternate landing zones, or holding patterns, etc.).

As described above, the communication system for the unmanned aircraft system may respond to the occurrence of the loss in the communication link (e.g., by rerouting via terrestrial or broadcast channels, etc.), thus improving the flight operation and the stability of the unmanned aircraft system. Furthermore, although the loss occurs in the communication link, the communication system is able to communicate with the mobility apparatus, the remote pilot station, and the air traffic control, thus improving the reliability of the flight operation. Furthermore, if the loss occurs in the communication link, the communication system may use the existing terrestrial communication network (e.g., public telecom infrastructure, leased private lines, or government emergency networks, etc.), thus reducing the cost of constructing the infrastructure.

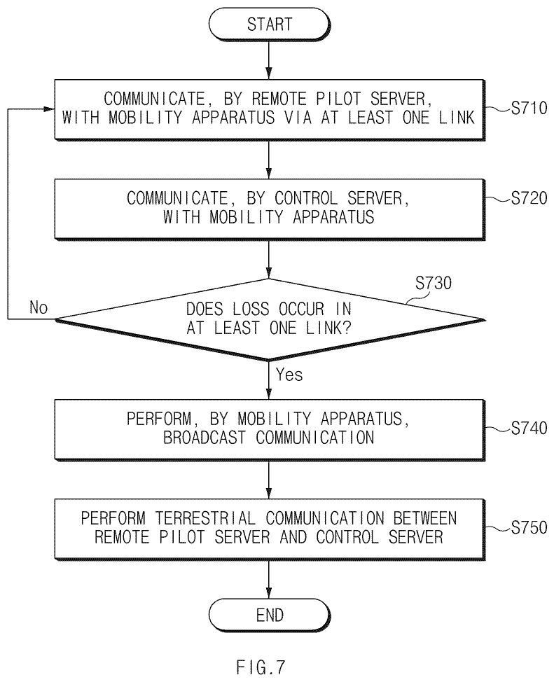

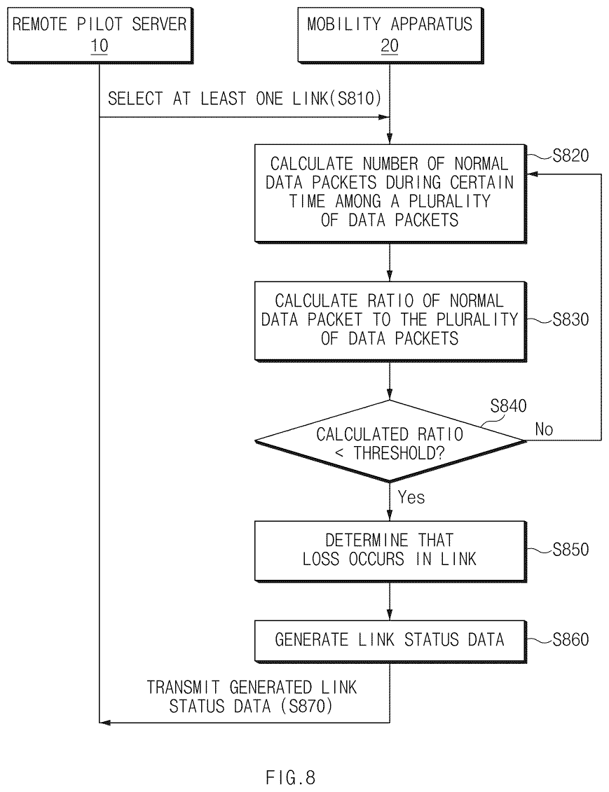

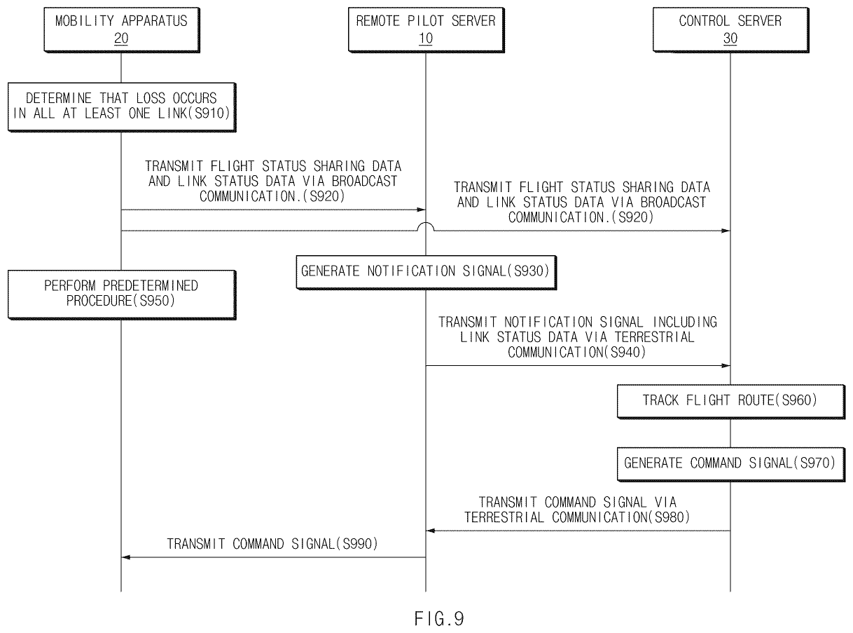

Hereinafter, a description will be given in detail of a communication method for an unmanned aircraft system of the present disclosure with reference to FIG. 7, FIG. 8, and FIG. 9.

Hereinafter, it is assumed that a communication system 2 of FIG. 2 performs processes of FIGS. 7 to 9. Furthermore, in descriptions of FIGS. 7 to 9, it may be understood that an operation described as being performed by an apparatus is controlled by the communication system 2 (e.g., execution of link selection, broadcast communication, or terrestrial communication, etc.).

FIG. 7 shows an example of a communication method for an unmanned aircraft system according to an example of the present disclosure.

Referring to FIG. 7, in S710, a remote pilot server may communicate with a mobility apparatus via at least one link to control flight of the mobility apparatus (e.g., transmitting telecommands, updating waypoints, or adjusting altitude, etc.).

In S720, a control server may communicate with the mobility apparatus to provide a flight route of the mobility apparatus (e.g., a direct route, detour route, or holding pattern, etc.).

In S730, the mobility apparatus may determine that a loss occurs in the at least one link (e.g., based on packet loss, signal quality degradation, or timeout events, etc.).

If the loss does not occur in the at least one link, the mobility apparatus may continue transmitting and receiving data with the remote pilot server via the at least one link. Alternatively, the mobility apparatus may restart the process from S710 (e.g., to re-initiate periodic link checks or confirm connectivity status, etc.).

If the loss occurs in the at least one link, in S740, the mobility apparatus may perform broadcast communication (e.g., using ADS-B, satellite-based messaging, or other one-to-many protocols, etc.).

Simultaneously, in S750, the mobility apparatus may perform terrestrial communication between the remote pilot server and the control server (e.g., relaying messages over a 5G network, fiber link, or secure VPN, etc.).

FIG. 8 and FIG. 9 show an example of a communication method for an unmanned aircraft system according to an example of the present disclosure. FIG. 8 is an example in which a loss occurs in at least one of a plurality of links. FIG. 9 is an example in which a loss occurs in all of a plurality of links.

Referring to FIG. 8, in S810, a link selection module of a remote pilot server 10 may select at least one link to communicate with a mobility apparatus 20 (e.g., C-band, UHF, or LTE, etc.).

In S820, a link loss determination module of the mobility apparatus 20 may calculate the number of normal data packets during a certain time among a plurality of data packets received in the link.

In S830, the link loss determination module may calculate a ratio of the normal data packets to the plurality of data packets during the certain time (e.g., 95% valid packets vs. 5% lost packets, etc.).

In S840, the link loss determination module may determine whether the calculated ratio is less than a threshold (e.g., 90% packet integrity threshold, etc.).

If the calculate ratio is greater than or equal to the threshold, the link loss determination module may determine that a loss does not occur in the link (e.g., normal operational state, etc.).

On the other hand, if the calculated ratio is less than the threshold, in S850, the link loss determination module may determine that the loss occurs in the link (e.g., degraded operational state, etc.).

In S860, the link loss determination module may generate link status data based on the determined result. Herein, the link status data may include a link status value for the link, the calculated result, and the determined result (e.g., “Link 2: 75% integrity—FAIL,” etc.).

In S870, the link loss determination module may transmit the generated link status data to a link loss detection module of the remote pilot server 10.

Referring to FIG. 9, in S910, the link loss determination module of the mobility apparatus 20 may determine that the loss occurs in all the at least one link (e.g., total communication blackout, etc.). At this time, if the loss occurs in all the links, communication between the mobility apparatus 20 and the remote pilot server 10 may be impossible or unstable.

In S920, a broadcast communication module of the mobility apparatus 20 may transmit flight status sharing data and link status data to the remote pilot server 10 and a control server 30 via broadcast communication (e.g., ADS-B extended squitter or satellite broadcast, etc.).

If it is detected that the loss occurs in all the links capable of communicating with the mobility apparatus 20, in S930, the link loss detection module of the remote pilot server 10 may generate a notification signal including the link status data (e.g., “ALL LINKS DOWN—last known position: 35.6895° N, 139.6917° E,” etc.).

In S940, a link loss transmission module of the remote pilot server 10 may transmit the notification signal including the link status data to the control server 30 via terrestrial communication MT (e.g., fiber optic line, MPLS link, or secure cloud-based messaging, etc.).

In S950, a control module of the mobility apparatus 20 may control to perform a predetermined procedure. For example, the predetermined procedure may include return to home (RTH) or auto landing (e.g., at nearest designated landing pad, etc.).

In S960, a route control module of the control server 30 may receive current location data of the mobility apparatus 20 to track a flight route of the mobility apparatus 20 (e.g., comparing to flight plan waypoints, etc.).

If the at least one link is normalized, in S970, the route control module may generate a command signal for a mission which should be performed by the mobility apparatus 20 (e.g., resume survey pattern, deliver payload, or continue inspection route, etc.).

In S980, a link loss reception module of the control server 30 may transmit the command signal to the remote pilot server 10 via terrestrial communication (e.g., IP-based secure channel, etc.).

If the at least one link is normalized, in S990, the remote pilot server 10 may transmit the received command signal to the mobility apparatus 20. Thereafter, the remote pilot server 10 may immediately control flight of the mobility apparatus 20 based on the received command signal (e.g., resuming manual pilot control or semi-autonomous operations, etc.).

Although the loss occurs in all the links in an airspace where control is required via the above-mentioned process, the control server 30 may avoid or cope with a risk situation in which a plurality of mobility apparatus collide with each other (e.g., issuing deconfliction commands, adjusting altitudes, or rerouting other aircraft, etc.).

As described above, the communication method for the unmanned aircraft system may respond to the occurrence of the loss in the communication link (e.g., partial packet loss, complete link failure, or intermittent signal drop, etc.), thus improving the flight operation and the stability of the unmanned aircraft system. Furthermore, although the loss occurs in the communication link, the communication method is able to communicate with the mobility apparatus, the remote pilot station, and the air traffic control (e.g., for transmitting mission-critical updates, rerouting instructions, or emergency status reports, etc.), thus improving the reliability of the flight operation. Furthermore, if the loss occurs in the communication link, the communication method may use an existing terrestrial communication network (e.g., 4G/5G cellular, wired fiber, or public safety radio network, etc.), thus reducing the cost of constructing the infrastructure.

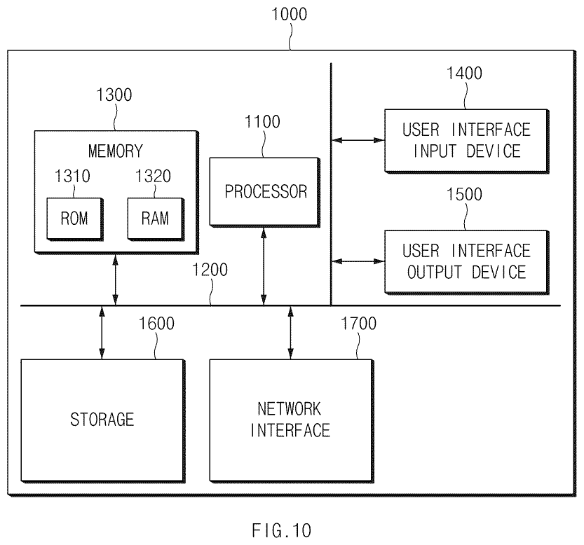

FIG. 10 shows an example of a computing system 1000 according to an example of the present disclosure.

Referring to FIG. 10, a computing system 1000 may include at least one processor 1100, a memory 1300, a user interface input device 1400, a user interface output device 1500, a storage 1600, and a network interface 1700, which are connected with each other via a bus 1200.

The processor 1100 may be a central processing unit (CPU) or a semiconductor device that processes instructions stored in the memory 1300 and/or the storage 1600 (e.g., SSD, flash memory, or HDD, etc.). The memory 1300 and the storage 1600 may include various types of volatile or non-volatile storage media. For example, the memory 1300 may include a read only memory (ROM) 1310 and a random access memory (RAM) 1320 (e.g., DRAM or SRAM).

Accordingly, the operations of the method or algorithm described in connection with the examples disclosed in the specification may be directly implemented with a hardware module, a software module, or a combination of the hardware module and the software module, which is executed by the processor 1100. The software module may reside on a storage medium (i.e., the memory 1300 and/or the storage 1600) such as a RAM, a flash memory, a ROM, an EPROM, an EEPROM, a register, a hard disc, a removable disk, and a CD-ROM (e.g., SSD, USB drive, or optical media).

The exemplary storage medium may be coupled to the processor 1100. The processor 1100 may read out information from the storage medium and may write information in the storage medium. Alternatively, the storage medium may be integrated with the processor 1100. The processor and the storage medium may reside in an application specific integrated circuit (ASIC). The ASIC may reside within a user terminal (e.g., an onboard vehicle controller or mobile computing platform). In another case, the processor and the storage medium may reside in the user terminal as separate components.

The user interface input device 1400 may include an input device (e.g., a touchscreen panel, physical buttons, a joystick, or a voice recognition module, etc.) that receives a user input.

The user interface output device 1500 may include a display for displaying various pieces of information associated with a flight status, navigation path, or system health of the mobility apparatus and/or a function of the mobility apparatus and a speaker for outputting various sounds (e.g., alerts, warnings, voice prompts, or status confirmations, etc.) associated with the flight of the mobility apparatus and/or the function of the mobility apparatus.

Herein, the display may provide a user interface for allowing a pilot of a remote pilot station and a mobility apparatus to interact with each other. For example, the display may include a liquid crystal display (LCD) panel and/or a light emitting diode (LED) display, or an organic light emitting diode (OLED) display for higher contrast and visibility in bright environments.

The network interface 1700 may include a long range communication module and/or a short range communication module, which transmit(s) and receive(s) data with an external device (e.g., a server or a user terminal) (e.g., a server, a control tower system, or a user terminal, etc.). For example, the network interface 1700 may refer to a communication module capable of performing wireless Internet communication, such as a wireless LAN (WLAN), wireless broadband (Wibro), wireless-fidelity (Wi-Fi), world interoperability for microwave access (WiMAX), or high speed downlink packet access (HSDPA), long-term evolution (LTE), or 5G new radio (NR) communication.

The present technology may respond to an occurrence of a loss in a communication link (e.g., sudden disconnection, degraded bandwidth, or latency spikes, etc.), thus improving flight operation and stability of an unmanned aircraft system.

Furthermore, the present technology is able to communicate with a mobility apparatus, a remote pilot station, and air traffic control, although the loss occurs in the communication link (e.g., through rerouting via a terrestrial network or using backup satellite connectivity, etc.), thus improving reliability of the flight operation.

Furthermore, the present technology may use an existing terrestrial communication network (e.g., 4G/5G cellular, public safety LTE, or fiber-optic backbone, etc.), if the loss occurs in the communication link, thus reducing the cost of constructing new infrastructure.

An example of the present disclosure provides a communication system for an unmanned aircraft system for determining a loss in multiple communication links and controlling communication depending on the determined result and a method therefor.

Another example of the present disclosure provides a communication system for an unmanned aircraft system, which is capable of communicating with a mobility apparatus, a remote pilot station, and air traffic control, although a loss occurs in a communication link, and a method therefor.

The technical problems to be solved by the present disclosure are not limited to the aforementioned problems, and any other technical problems not mentioned herein will be clearly understood from the following description by those skilled in the art to which the present disclosure pertains.

According to an example of the present disclosure, a communication system for an unmanned aircraft system may include a mobility apparatus, a remote pilot server that communicates with the mobility apparatus via at least one link to control flight of the mobility apparatus, and a control server that communicates with the mobility apparatus to provide a flight route of the mobility apparatus. The mobility apparatus may perform broadcast communication and may perform terrestrial communication between the remote pilot server and the control server, if determining that a loss occurs in the at least one link.

In an example, the remote pilot server may include a link selection module that selects the at least one link to communicate with the mobility apparatus and assign a priority to the at least one link, a link loss detection module that detects the loss in the at least one link and generates a notification signal including link status data based on the detected result, and a link loss transmission module that transmits the notification signal to the control server via the terrestrial communication.

In an example, the mobility apparatus may include a link loss determination module that determines whether the loss occurs based on a plurality of data packets received in the at least one link and a broadcast communication module that transmits flight status sharing data via the broadcast communication based on the determined result.

In an example, the link loss determination module may calculate the number of normal data packets during a certain time among the plurality of data packets.

In an example, the link loss determination module may determine a data packet, integrity of which is verified by a checksum, among the plurality of data packets as the normal data packet.

In an example, the link loss determination module may calculate a ratio of the normal data packets to the plurality of data packets during the certain time and may generate the link status data based on the calculated result.

In an example, the link loss determination module may determine that the loss occurs in the at least one link, if the ratio of the normal data packets received in the at least one link is less than a threshold, and may transmit the link status data generated based on the determined result to the link loss detection module.

In an example, the broadcast communication module may transmit the flight status sharing data and the link status data, if the link loss determination module determines that the loss occurs in all the at least one link.

In an example, the control server may include a route control module that determines the mobility apparatus flies along a predetermined flight route and generates a command signal for the flight route and a link loss reception module that receives the notification signal including the link status data via the terrestrial communication.

In an example, the link loss reception module may transmit the command signal to the link loss transmission module, if the loss occurs in all the at least one link.

According to another example of the present disclosure, a communication method for an unmanned aircraft system may include communicating, by a remote pilot server, with the mobility apparatus via at least one link to control flight of the mobility apparatus, communicating, by a control server, with the mobility apparatus to provide a flight route of the mobility apparatus, determining, by the mobility apparatus, that a loss occurs in the at least one link, performing, by the mobility apparatus, broadcast communication, and performing, by the mobility apparatus, terrestrial communication between the remote pilot server and the control server.

In another example, the communicating with the mobility apparatus via the at least one link may include selecting the at least one link to communicate with the mobility apparatus, assigning a priority to the at least one link, detecting the loss in the at least one link, generating a notification signal including link status data based on the detected result, and transmitting the notification signal to the control server via the terrestrial communication.

In another example, the determining that the loss occurs may include determining whether the loss occurs based on a plurality of data packets received in the at least one link. The performing of the broadcast communication may include transmitting flight status sharing data via the broadcast communication based on the determined result.

In another example, the determining of whether the loss occurs may include calculating the number of normal data packets during a certain time among the plurality of data packets.

In another example, the determining of whether the loss occurs may further include determining a data packet, integrity of which is verified by a checksum, among the plurality of data packets as the normal data packet.

In another example, the determining of whether the loss occurs may include calculating a ratio of the normal data packets to the plurality of data packets during the certain time and generating the link status data based on the calculated result.

In another example, the determining of whether the loss occurs may further include determining that the loss occurs in the at least one link, if the ratio of the normal data packets received in the at least one link is less than a threshold, and transmitting the link status data generated based on the determined result to the remote pilot server.

In another example, the transmitting of the flight status sharing data may include transmitting the flight status sharing data and the link status data, if the mobility apparatus determines that the loss occurs in all the at least one link.

In another example, the communicating with the mobility apparatus to provide the flight route may include determining whether the mobility apparatus flies along a predetermined flight route, generating a command signal for the flight route, and receiving the notification signal including the link status data via the terrestrial communication.

In another example, the communicating with the mobility apparatus to provide the flight route may further include transmitting the command signal to the remote pilot server, if the loss occurs in all the at least one link.

In addition, various effects ascertained directly or indirectly through the present disclosure may be provided.

Hereinabove, although the present disclosure has been described with reference to examples and the accompanying drawings, the present disclosure is not limited thereto, but may be variously modified and altered by those skilled in the art to which the present disclosure pertains without departing from the spirit and scope of the present disclosure claimed in the following claims.

Therefore, examples of the present disclosure are not intended to limit the technical spirit of the present disclosure, but provided only for the illustrative purpose. The scope of the present disclosure should be construed on the basis of the accompanying claims, and all the technical ideas within the scope equivalent to the claims should be included in the scope of the present disclosure.

What is claimed is:

1. A communication system comprising:
a remote pilot server configured to communicate with an aircraft via at least one link to control flight of the aircraft; and
a control server configured to communicate with the aircraft to provide a flight route of the aircraft,
wherein at least one of the remote pilot server or the control server is configured to receive broadcast communication transmitted from the aircraft, wherein the broadcast communication is based on a loss in the at least one link, and
wherein, based on detection of the loss, the remote pilot server and the control server are configured to perform terrestrial communication between the remote pilot server and the control server.

2. The communication system of claim 1, wherein the remote pilot server comprises:
a wireless transceiver configured to establish at least one communication channel via the at least one link;
a processor; and
a memory storing at least one instruction that, when executed by the processor communicating with the memory, is configured to cause the remote pilot server to:
select the at least one link to communicate with the aircraft and assign a priority to the at least one link;
detect the loss in the at least one link and generate a notification signal, wherein the notification signal comprises link status data of the at least one link based on the detection of the loss; and
transmit, via the terrestrial communication, the notification signal to the control server.

3. The communication system of claim 2, wherein the communication system comprises the aircraft, and wherein at least one of the aircraft or the remote pilot server comprises:
a processor; and
a memory storing at least one instruction that, when executed by the processor communicating with the memory, is configured to cause the at least one of the aircraft or the remote pilot server to:
determine, based on a plurality of data packets received in the at least one link, whether the loss occurs ; and
communicate, via the broadcast communication, flight status data of the aircraft based on the determination of whether the loss occurs.

4. The communication system of claim 3, wherein the at least one instruction, when executed by the processor communicating with the memory, is configured to cause the at least one of the aircraft or the remote pilot server to
identify a quantity of data packets corresponding to normal data packets, and wherein the identified data packets are among a plurality of data packets received via the at least one link during a preset time period.

5. The communication system of claim 4, wherein the at least one instruction, when executed by the processor communicating with the memory, is configured to cause the at least one of the aircraft or the remote pilot server to verify, using a checksum, the data packets to determine whether the data packets are the normal data packets.

6. The communication system of claim 5, wherein the at least one instruction, when executed by the processor communicating with the memory, is configured to cause the at least one of the aircraft or the remote pilot server to:
determine a ratio of a quantity of the normal data packets to a quantity of the plurality of data packets received via the at least one link during the preset time period; and
generate, based on the ratio, the link status data.

7. The communication system of claim 6, wherein the at least one instruction, when executed by the processor communicating with the memory, is configured to cause the remote pilot server to:
based on the ratio being less than a threshold, determine that the loss occurs in the at least one link; and
receive, based on the determination of the loss, the link status data from the aircraft.

8. The communication system of claim 7, wherein the at least one instruction, when executed by the processor communicating with the memory, is configured to cause at least one of the aircraft or the remote pilot server to:
based on a determination that a loss occurs in all of the at least one link, perform the broadcast communication by communicating, via a broadcast communication link, the flight status data and the link status data.

9. The communication system of claim 8, wherein the control server comprises:
a processor; and
a memory storing at least one instruction that, when executed by the processor communicating with the memory, is configured to cause the control server to:
determine that the aircraft flies along a predetermined flight route and generate, based on the predetermined flight route, a command signal for the flight route, and
receive, via the terrestrial communication, the notification signal comprising the link status data.

10. The communication system of claim 9, wherein the at least one instruction, when executed by the processor communicating with the memory, is configured to cause the control server to:
based on all of the at least one link being lost, generate the command signal, and
transmit, via the terrestrial communication, the command signal to the remote pilot server.

11. A method performed by a communication system, the method comprising:
communicating, by a remote pilot server of the communication system, with an aircraft of the communication system via at least one link to control flight of the aircraft;
communicating, by a control server of the communication system, with the aircraft to provide a flight route of the aircraft;
receiving, by at least one of the remote pilot server or the control server, broadcast communication transmitted from the aircraft, wherein the broadcast communication is based on a loss in the at least one link; and
based on detection of the loss, performing, by the remote pilot server and the control server, terrestrial communication between the remote pilot server and the control server.

12. The method of claim 11, wherein the communicating with the aircraft via the at least one link comprises:
establishing at least one communication channel via the at least one link;
selecting the at least one link to communicate with the aircraft;
assigning a priority to the at least one link;
detecting the loss in the at least one link;
generating a notification signal comprising link status data of the at least one link based on the detection of the loss; and
transmitting, via the terrestrial communication, the notification signal to the control server.

13. The method of claim 11, further comprising:
determining, based on a plurality of data packets received in the at least one link, whether the loss occurs, and
wherein the performing of the broadcast communication comprises:
transmitting, via the broadcast communication, flight status data of the aircraft based on the determining of whether the loss occurs.

14. The method of claim 11, further comprising:
identifying a quantity of data packets corresponding to normal data packets, wherein the identified data packets are among a plurality of data packets received in the at least one link during a preset time period.

15. The method of claim 14, wherein the determining of whether the loss occurs comprises:
verifying, using a checksum, the data packets to determine whether the data packets are the normal data packets.

16. The method of claim 15, further comprising:
determining a ratio of a quantity of the normal data packets to a quantity of the plurality of data packets received via the at least one link during the preset time period; and
generating, based on the ratio, link status data of the at least one link.

17. The method of claim 16, further comprising:
based on the ratio being less than a threshold, determining that the loss occurs in the at least one link; and
based on the determining of the loss, receiving, by the remote pilot server from the aircraft, the link status data.

18. A vehicle control system comprising:
a vehicle comprising:
a plurality of primary wireless communication links configured to communicate with a remote pilot station and a control server;
a broadcast communication link configured to transmit data using a broadcast protocol;
at least one processor circuit operatively connected to the plurality of primary wireless communication links and the broadcast communication link, wherein the at least one processor circuit is configured to:
receive a plurality of data packets via the plurality of primary wireless communication links,
verify, using a checksum, integrity of each of the plurality of data packets,
determine, over a defined period, a ratio of data packets with verified integrity to a total number of data packets received,
compare the ratio of data packets to a threshold ratio to detect a loss in at least one of the plurality of primary wireless communication links,
generate, based on the comparison, link status data of the plurality of primary wireless communication links,
transmit the link status data to the remote pilot station via an available one of the plurality of primary wireless communication links, and
based on detecting a loss in all of the plurality of primary wireless communication links, transmit, via the broadcast communication link, operation status data of the vehicle and the link status data;
the remote pilot station comprising:
a terrestrial communication link;
a broadcast communication link; and
at least one processor circuit configured to:
based on all of the plurality of primary wireless communication links being unavailable, receive, via the broadcast communication link, the link status data and the operation status data from the vehicle,
generate a notification signal comprising the link status data, and
transmit the notification signal to the control server via the terrestrial communication link,
based on restoration of at least one primary wireless communication link of the plurality of primary wireless communication links, transmit, via the at least one primary wireless communication link to the vehicle, a command signal for controlling the vehicle; and
the control server comprising:
a terrestrial communication link; and
at least one processor configured to:
receive, via the terrestrial communication link of the control server, the notification signal from the remote pilot station,
determine, based on the notification signal, a route for the vehicle, and
transmit, via the terrestrial communication link of the control server, the command signal to the remote pilot station.

19. The vehicle control system of claim 18, wherein the at least one processor circuit of the vehicle is further configured to, based on the detecting of the loss in all of the plurality of primary wireless communication links, perform at least one of a return-to-home operation or an automatic landing operation.

20. The vehicle control system of claim 18, wherein the link status data of the plurality of primary wireless communication links comprises, for each of the plurality of primary wireless communication links:
a link status value indicating whether data packets have been successfully received during the defined period,
the ratio of data packets with verified integrity to the total number of data packets received during the defined period, and
a result of the comparison of the ratio of data packets with verified integrity to the threshold ratio.
